(19) United States
(12) Patent Application Publication
(10) Pub. No.: US 2026/0307791 A1
(43) Pub. Date: Oct. 8, 2026

(54) Assist and Transfer Handles in Aircraft Lavatories

(71) Applicant: B/E Aerospace, Inc., Winston-Salem, NC (US)

(72) Inventors: Travis John Vaninetti, Bothell, WA (US); Geoffrey L. Eisenhardt, Phoenix, AZ (US); Patrick Michael Quinn, Winston-Salem, NC (US)

(73) Assignee: B/E Aerospace, Inc., Winston-Salem, NC (US)

(21) Appl. No.: 19/637,881

(22) Filed: Apr. 2, 2026

Related U.S. Application Data
(60) Provisional application No. 63/783,615, filed on Apr. 4, 2025.

(51) Int. Cl. B64D 11/00; B65F 1/14

(52) U.S. Cl. CPC B64D 11/00; B65F 1/1426

(57) ABSTRACT

An aircraft lavatory may comprise assist handles disposed approximately waist-height for a standing passenger and may comprise transfer handles disposed approximately waist-height for seated passengers. The transfer handles may be disposed below the assist handles for use by passengers transferring in and out of a wheelchair or other mobility device. The assist handles may extend between a sink and a rear wall of the aircraft lavatory and may wrap around to a rear wall of the aircraft lavatory. The transfer handles may comprise transfer handles protruding from the first wall, or a trash receptacle disposed on the first wall. The transfer handles may comprise transfer handles protruding from a center wall of the lavatory. The center wall may be disposed between a first single lavatory and a second single lavatory such that the aircraft lavatory may be convertible between a single lavatory configuration and a dual lavatory configuration.

### CROSS REFERENCE TO RELATED APPLICATIONS

This application claims the benefit of and priority to U.S. Provisional Application Number 63/783,615, entitled “ASSIST AND TRANSFER HANDLES IN AIRCRAFT LAVATORIES,” filed on Apr. 4, 2025, which is hereby incorporated by reference in its entirety for all purposes.

### TECHNICAL FIELD

The present disclosure relates generally to aircraft lavatories and, more particularly, to aircraft lavatories with assist handles and transfer handles for wheelchair occupants.

### BACKGROUND

Aircraft lavatories may be difficult to access for passengers who use wheelchairs or other mobility devices. Space constraints in aircraft design tend to lead to designs that may not fully account for the needs of passengers who use wheelchairs or other mobility devices. Lavatories have size constraints that may make transfer from a wheelchair or other mobility device difficult. This presents a challenge for those with mobility. Space constraints in lavatories, especially lavatories on narrowbody aircraft, may make it difficult to provide transfer handles in convenient locations.

### SUMMARY

In one aspect, an aircraft lavatory is disclosed. In various embodiments, the aircraft lavatory may comprise a first wall extending between a door and a rear wall, a center wall opposing the first wall, an assist handle, and a first transfer handle disposed below the assist handle.

In various embodiments, the aircraft lavatory may comprise a sink disposed on the first wall proximate the door.

In various embodiments, a width the first wall may be defined by a first distance. In various embodiments, the sink may extend along the first wall a second distance. In various embodiments, the assist handle may extend along the first wall a third distance such that the first distance is equivalent to a sum of the second distance and the third distance.

In various embodiments, the assist handle may wrap from the first wall to the rear wall and may extend a length of the rear wall.

In various embodiments, the rear wall may be an outboard wall of an aircraft.

In various embodiments, the aircraft lavatory may comprise a second transfer handle extending from the center wall at a height below a height of the assist handle.

In various embodiments, the aircraft lavatory may comprise a trash receptacle disposed on the first wall between the sink and the rear wall.

In various embodiments, the assist handle may be disposed vertically above the trash receptacle. In various embodiments, the first transfer handle may be coupled to the trash receptacle.

In another aspect, an aircraft lavatory is disclosed. In various embodiments, the aircraft lavatory may comprise a first single lavatory including a first assist handle disposed on a first wall of the first single lavatory and a first transfer handle disposed on the first wall of the first single lavatory below the first assist handle. In various embodiments, the aircraft lavatory may comprise a second single lavatory including a second assist handle disposed on a second wall of the second single lavatory and a second transfer handle disposed on the second wall of the second single lavatory below the second assist handle. In various embodiments, the aircraft lavatory may comprise a center wall disposed between the first single lavatory and the second single lavatory. In various embodiments, the center wall may be convertible within the aircraft lavatory in order to convert the aircraft lavatory between a dual lavatory configuration and a single lavatory configuration.

In various embodiments, the first single lavatory may further include a sink disposed on the first wall proximate a first door of the first single lavatory and a trash receptacle disposed on the first wall between the sink and a rear wall of the first single lavatory.

In various embodiments, the first assist handle may extend along the first wall between the sink and the rear wall. In various embodiments, the first assist handle may be disposed vertically above the trash receptacle.

In various embodiments, the first assist handle may extend vertically above the trash receptacle. In various embodiments, the first transfer handle protrudes from the trash receptacle.

In various embodiments, the aircraft lavatory may comprise a third transfer handle disposed on the center wall, facing the first single lavatory, and below the first assist handle.

In various embodiments, the first transfer handle may define an elongated cutout.

In another aspect, an aircraft lavatory is disclosed. In various embodiments, the aircraft lavatory may comprise an aircraft lavatory including a first wall extending between a door and a rear wall, a center wall opposing the first wall, an assist handle, and a first transfer handle disposed below the assist handle.

In various embodiments, the aircraft may be a narrowbody aircraft and the rear wall is an outboard wall of the narrowbody aircraft.

In various embodiments, the aircraft lavatory may further comprise a sink disposed on the first wall proximate the door of the aircraft lavatory, and a trash receptacle disposed on the first wall between the sink and the rear wall of the aircraft lavatory.

In various embodiments, the assist handle may extend along the first wall between the sink and the rear wall. In various embodiments, the assist handle may be disposed vertically above the trash receptacle.

In various embodiments, the assist handle may extend vertically above the trash receptacle, and wherein the first transfer handle protrudes from the trash receptacle.

In various embodiments, the aircraft lavatory may further comprise a second transfer handle extending from the center wall at a height below a height of the assist handle.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan, in accordance with various embodiments;

FIG. 3 illustrates a pair of aircraft lavatories, in accordance with various embodiments;

FIG. 4 illustrates a pair of aircraft lavatories, in accordance with various embodiments;

FIG. 5 illustrates a pair of aircraft lavatories, in accordance with various embodiments;

FIG. 6 illustrates an aircraft lavatory, in accordance with various embodiments;

FIG. 7 illustrates a pair of aircraft lavatories, in accordance with various embodiments;

FIG. 8 illustrates an assist handle, in accordance with various embodiments;

FIG. 9 illustrates a transfer handle, in accordance with various embodiments; and

FIG. 10 illustrates a transfer handle, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

For the sake of brevity, conventional approaches for transferring to a lavatory seat from a wheelchair, mobility devices, and/or the like may not be described in detail herein. Furthermore, the connecting lines shown in various figures contained herein are intended to represent exemplary functional relationships and/or physical or communicative couplings between various elements. It should be noted that many alternative or additional functional relationships or physical or communicative connections may be present in a practical system and/or related methods of use.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion. As used herein “rear” refers to the direction of the lavatory opposing the lavatory doors (e.g. toward the fuselage wall). As used herein “front” refers to the direction of the lavatory facing the lavatory doors (e.g. toward the lavatory entrance).

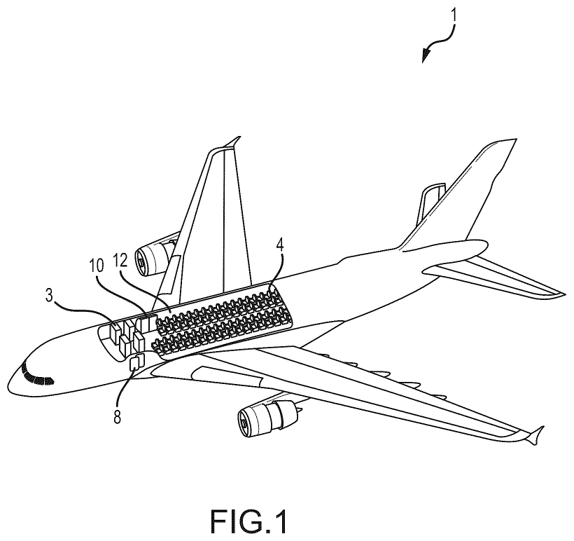

With initial reference to FIG. 1, an aircraft 1 is illustrated, in accordance with various embodiments. Aircraft 1 may comprise an aisle 6. Aircraft 1 may comprise a plurality of seats 4. Aircraft 1 may comprise one or more lavatories 10. Aircraft 1 may comprise a door 8. Aircraft 1 may comprise a wheelchair plinth 2. Wheelchair plinth 2 may be disposed proximate door 8. In various embodiments, aircraft 1 is a narrowbody aircraft having only one aisle 6.

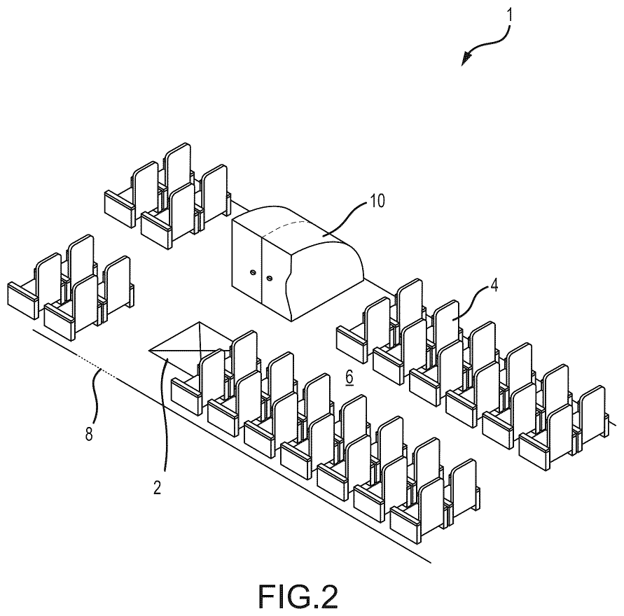

With initial reference to FIG. 2, a floor plan of aircraft 1 is illustrated, in accordance with various embodiments. As illustrated, wheelchair plinth 2 is disposed proximate lavatory 10. As illustrated, lavatory 10 is disposed proximate door 8. However, it should be understood that lavatory 10 may be disposed at any location within aircraft 1. Lavatory 10 may be a forward lavatory. Lavatory 10 may be an aft lavatory. Lavatory 10 may be a center lavatory. Lavatory 10 may be disposed along an outboard wall 12 of aircraft 1, as best shown in FIG. 1.

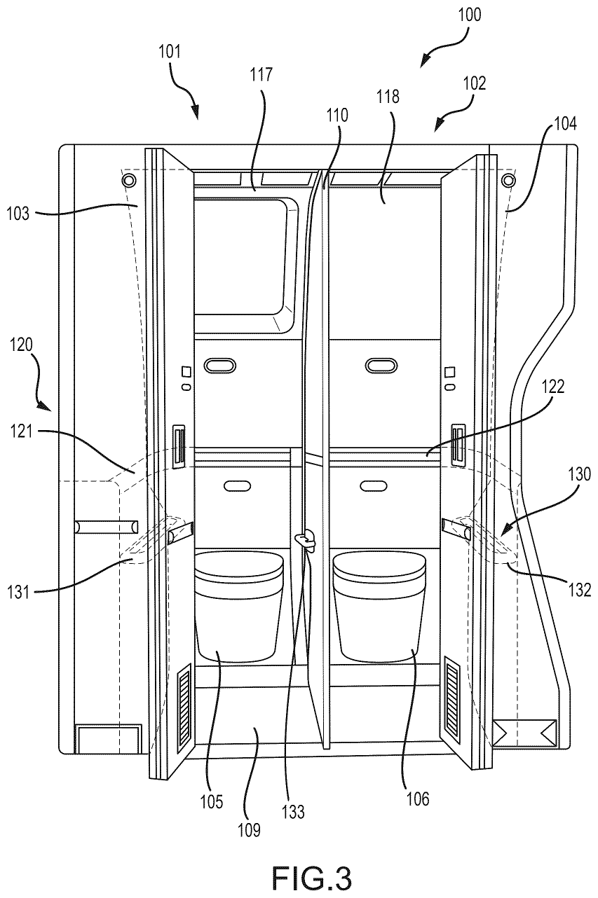

With reference to FIGS. 3-5, an aircraft lavatory 100 is illustrated. In various embodiments, aircraft lavatory 100 may comprise a first single lavatory 101 and a second single lavatory 102. However, it should be understood that the concepts described herein may be applicable to a single lavatory, either first single lavatory 101 alone or second single lavatory 102 alone. In various embodiments, aircraft lavatory 100 may comprise a first wall 103. The second single lavatory 102 may comprise a second wall 104. The first single lavatory 101 may comprise a first toilet 105. The second single lavatory 102 may comprise a second toilet 106. The first single lavatory 101 may comprise a first sink 107. The second single lavatory 102 may comprise a second sink 108. In various embodiments, aircraft lavatory 100 comprises a center wall 110. In various embodiments, the aircraft lavatory 100 may comprise a floor 109. In various embodiments, first single lavatory 101 may comprise a first rear wall 117 and second single lavatory 102 may comprise a second rear wall 118. Each of the first rear wall 117 and the second rear wall 118 may be curved walls. Each of the first rear wall 117 and the second rear wall 118 may be outboard walls, such as outboard wall 12.

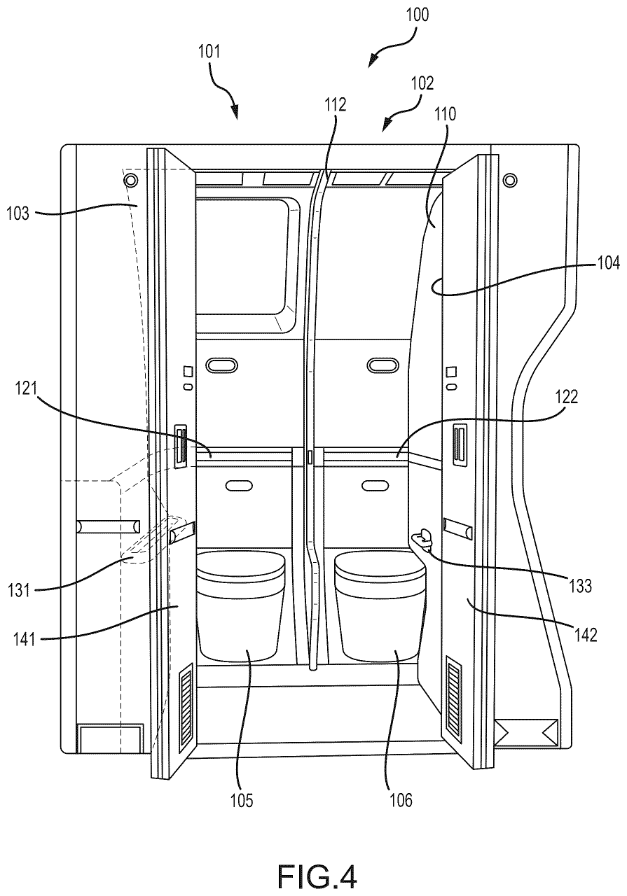

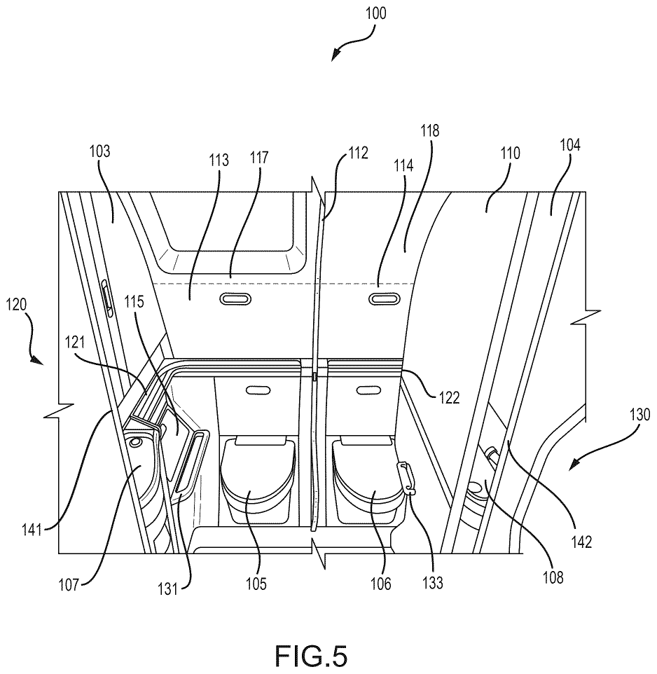

In various embodiments, aircraft lavatory may comprise a partial divider 112. Center wall 110 may be selectively coupled to the partial divider 112. In various embodiments, the center wall 110 may be slidable, removeable, foldable, or otherwise convertible such that aircraft lavatory 100 may be convertible between a single lavatory configuration and a dual lavatory configuration. As shown in FIG. 3, the center wall 110 may be coupled to the partial divider 112 to place the aircraft lavatory 100 in a dual-lavatory configuration. As shown in FIGS. 4 and 5, the center wall 110 may be disconnected from the partial divider 112 and translated to either one of the first wall 103 or the second wall 104 to place the aircraft lavatory 100 in an adaptable-lavatory configuration with increased space. The increased space may be beneficial for a passenger using a wheelchair or other mobility device.

In various embodiments, aircraft lavatory 100 may comprise one or more assist handles 120. For example, first single lavatory 101 may comprise a first assist handle 121 while second single lavatory 102 may comprise a second assist handle 122. Assist handles 120 may be located at approximately waist-level for a standing adult. Assist handles 120 may be located at a same (or substantially the same) height from a floor 109 than the first sink 107 and/or the second sink 108. Assist handles 120 may be located at a greater height from a floor 109 than the first sink 107 and/or the second sink 108. Assist handles 120 may be disposed at a height configured for the convenience and/or use of standing passengers, for example, during turbulence. The height of assist handles 120 may be at a height that is typically inconvenient for passengers needing to transfer from a wheelchair or mobility device to first toilet 105 and/or second toilet 106.

In various embodiments, aircraft lavatory 100 may comprise one or more transfer handles 130. For example, first single lavatory 101 may comprise a first transfer handle 131 while second single lavatory 102 may comprise a second transfer handle 132. In various embodiments, one or more third transfer handle 133 is disposed on center wall 110. Transfer handles 130 may be located at approximately waist-level for a seated adult. Transfer handles 130 may be located at a lower height from the floor 109 than the first sink 107 and/or the second sink 108. Transfer handles 130 may be disposed at a height configured for the convenience and/or use of seated passengers, for example, for transfer between a wheelchair and one of the first toilet 105 or the second toilet 106. The height of assist handles 120 may be at a height that is typically inconvenient for passengers needing to transfer from a wheelchair or mobility device to first toilet 105 and/or second toilet 106.

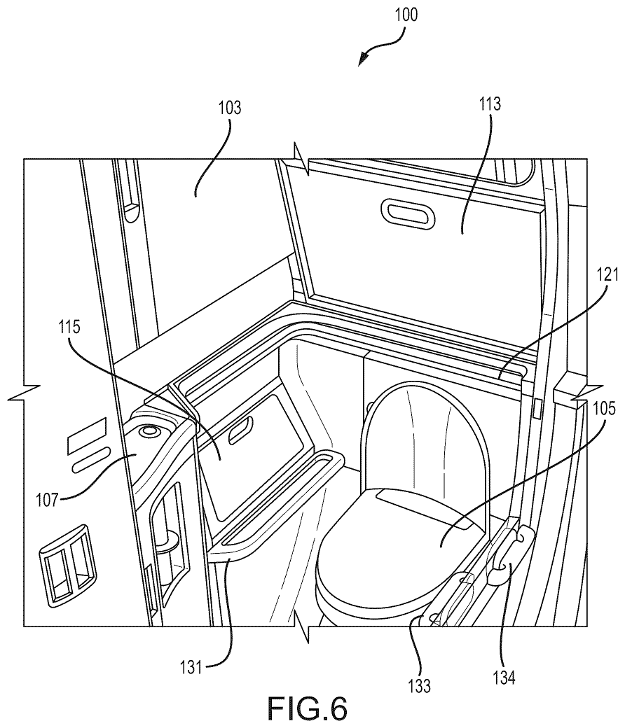

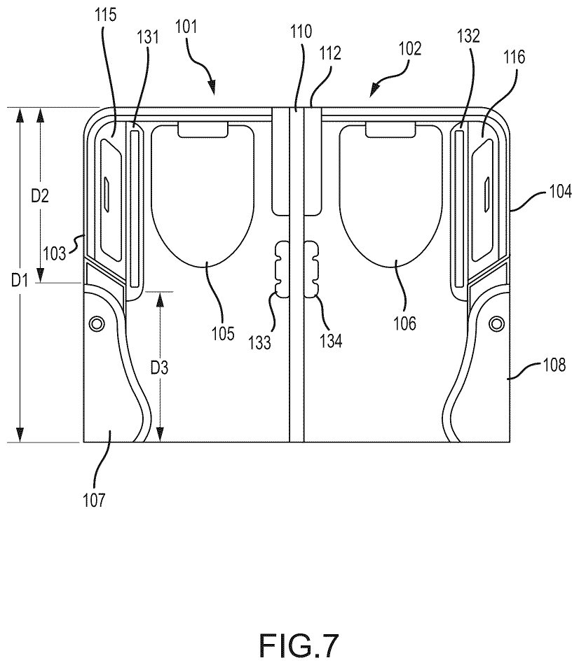

With respect to FIG. 5, a perspective view of the aircraft lavatory 100 is illustrated. Center wall 110 is proximate the second wall 104. In various embodiments, the first sink 107 is located along the first wall 103. In various embodiments, the first sink 107 is disposed proximate the first lavatory door 141. In various embodiments, a first changing table 113 is disposed on the first rear wall 117 vertically above the first toilet 105. In various embodiments, the second sink 108 is located along the second wall 104. In various embodiments, the second sink 108 is disposed proximate the second lavatory door 142. In various embodiments, a second changing table 114 is disposed on the second rear wall 118 vertically above the second toilet 106. In various embodiments, the first single lavatory 101 may comprise a first trash receptacle 115. The first trash receptacle 115 may be disposed on the first wall 103 between the first sink 107 and the first rear wall 117. Similarly, and as shown in FIG. 7, the second single lavatory 102 may comprise a second trash receptacle 116 disposed along the second wall 104 between the second sink 108 and the second rear wall 118.

In various embodiments, the assist handles 120 may extend along a side wall, such as first wall 103 or second wall 104. In various embodiments, assist handles 120 may extend between the first sink 107 and the first rear wall 117 or, similarly, between the second sink 108 and the second rear wall 118. In various embodiments, assist handles 120 may extend the width of a rear wall, such as first rear wall 117 or second rear wall 118. In various embodiments, assist handles 120 may extend along the first wall 103 or the second wall 104 and wrap around to and extend the width of the first rear wall 117 or the second rear wall 118, respectively. In various embodiments, assist handles 120 may extend along the first wall 103 or the second wall 104 and wrap around to and extend the width of the first rear wall 117 or the second rear wall 118, respectively. For example, first assist handle 121 may extend between the first sink 107 to the first rear wall 117 and wrap around to extend along the first rear wall 117. Said another way, the first assist handle 121 may extend between the first sink 107 and the partial divider 112. Similarly, and as shown in FIG. 7, the second assist handle 122 may extend between the second sink 108 and the partial divider 112.

In various embodiments, the assist handles 120 may be disposed below the first changing table 113 and/or the second changing table 114. For example, the first assist handle 121 may be disposed below the first changing table 113 as shown in FIG. 5. Similarly, the second assist handle 122 may be disposed below second changing table 114.

In various embodiments, the assist handles 120 may be disposed vertically above the first trash receptacle 115 and/or the second trash receptacle 116. For example, the first assist handle 121 may be disposed above the first trash receptacle as shown in FIG. 5. Similarly, the second assist handle 122 may be disposed above the second trash receptacle 116.

In various embodiments, the transfer handles 130 may be disposed at a lower height from the floor 109 than the assist handles 120. In various embodiments, the first transfer handle 131 may be disposed below a lid of the first trash receptacle 115. In various embodiments, the first transfer handle 131 may be coupled to the first trash receptacle 115. In various embodiments, the first transfer handle 131 may extend the width of the first trash receptacle 115. In various embodiments, the first transfer handle 131 may extend between the first sink 107 and the first rear wall 117. Similarly, and as shown in FIG. 7, the second transfer handle 132 may be disposed below a lid of the second trash receptacle 116. In various embodiments, the second transfer handle 132 may be coupled to the second trash receptacle 116. In various embodiments, the second transfer handle 132 may extend the width of the second trash receptacle 116. In various embodiments, the second transfer handle 132 may extend between the second sink 108 and the second rear wall 118.

In various embodiments and with particular reference to FIGS. 5-7, a third transfer handle 133 may be disposed on the center wall 110 facing the first single lavatory 101. In various embodiments, a fourth transfer handle 134 may be disposed on the center wall 110 facing the second single lavatory 102. In various embodiments, each of the third transfer handle 131 and the fourth transfer handle 132 may be disposed at a lower height from the floor 109 than the assist handles 120. In various embodiments, each of the third transfer handle 131 and the fourth transfer handle 132 may be disposed at a lower height from the floor 109 than the first changing table 113 and the second changing table 114. As such, each of the first toilet 105 and the second toilet 106, when in use, are disposed between a pair of transfer handles 130.

With reference to FIG. 7, each of the first wall 103 and the fourth wall 140, at a greatest width, may measure a first distance D1. The first distance D1 may be between 26 inches and 50 inches. The first distance D1 may be between 32 inches and 44 inches. The first distance D1 may be between 34 inches and 40 inches. Each of the first transfer handle 131 and the second transfer handle 132 may measure a second distance D2. The second distance D2 may be between 11 inches and 24 inches. The second distance D2 may be between 14 inches and 21 inches. The second distance D2 may be between 16 inches and 19 inches. Similarly, each of the portion of the first assist handle 121 disposed along the first wall 103 and the portion of the second assist handle 122 disposed along the second wall 104 may measure the second distance D2. Each of the first sink 107 and the second sink 108 may measure a third distance D3. The third distance D3 may be between 15 inches and 27 inches. The third distance D3 may be between 17 inches and 24 inches. The third distance D3 may be between 19 inches and 22 inches. In various embodiments, the first distance D1 may be equivalent to a sum of the second distance D2 and the third distance D3.

With reference to FIG. 8, an enlarged view of the first assist handle 121 is illustrated. It should be understood that the second assist handle 122 may be substantially similar to the first assist handle 121. The first assist handle 121 may be a protruding ridge extending from the first wall 103 and the first rear wall 117. The first assist handle 121 may be a continuous ridge.

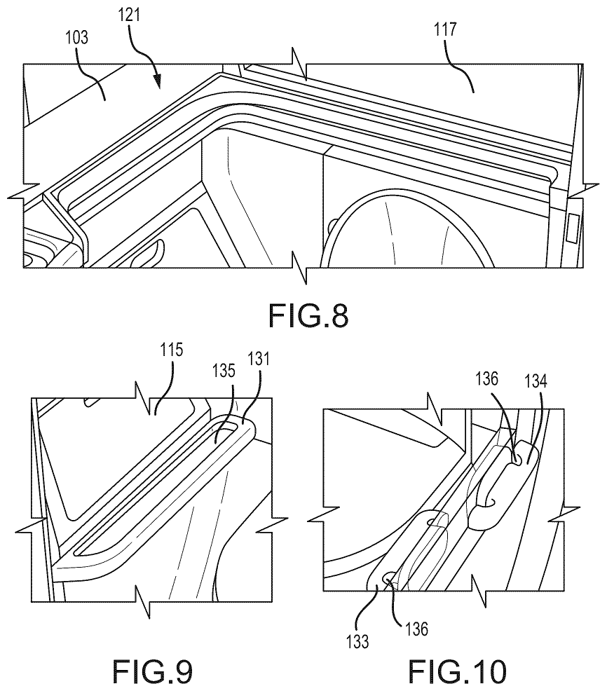

With reference to FIG. 9, an enlarged view of the first transfer handle 131 is illustrated. It should be understood that the second transfer handle 132 may be substantially similar to the first transfer handle 131. The first transfer handle 131 may protrude from the first trash receptacle 115. The first transfer handle 131 may define an elongated cutout 135 configured to assist a passenger in ergonomically grabbing ahold of the first transfer handle 131. The elongated cutout 135 may be a through hole defined through a center of the first transfer handle 131.

With reference to FIG. 10, an enlarged view of the third transfer handle 133 and the fourth transfer handle 134 is illustrated. Each of third transfer handle 133 and the fourth transfer handle 134 may protrude opposing sides of the center wall 110. Each of third transfer handle 133 and the fourth transfer handle 134 may define thumb pockets 136 configured to assist a passenger in ergonomically grabbing ahold of the third transfer handle 133 and/or the fourth transfer handle 134. In various embodiments, the thumb pockets 136 may be a through holes defined through each of the third transfer handle 133 and the fourth transfer handle 134. In various embodiments, the thumb pockets 136 may be recessed contours defined into each of the third transfer handle 133 and the fourth transfer handle 134.

The assist handles 120 and transfer handles 130 described herein may provide for easier transfer of a passenger between the lavatory and a wheelchair and/or mobility device. The assist handles 120 and transfer handles 130 described herein may provide for increased safety for passengers with reduced mobility. The assist handles 120 and transfer handles 130 described herein may provide for various height and angles of gripping surfaces for passengers within the lavatory. The assist handles 120 and transfer handles 130 described herein may provide for increased comfort and convenience for passengers with reduced mobility.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An aircraft lavatory, comprising:
a first wall extending between a door and a rear wall;
a center wall opposing the first wall;
an assist handle; and
a first transfer handle disposed below the assist handle.

2. The aircraft lavatory of claim 1, further comprising a sink disposed on the first wall proximate the door.

3. The aircraft lavatory of claim 2, wherein a width the first wall is defined by a first distance, and wherein the sink extends along the first wall a second distance, and wherein the assist handle extends along the first wall a third distance such that the first distance is equivalent to a sum of the second distance and the third distance.

4. The aircraft lavatory of claim 1, wherein the assist handle wraps from the first wall to the rear wall and extends a length of the rear wall.

5. The aircraft lavatory of claim 1, wherein the rear wall is an outboard wall of an aircraft.

6. The aircraft lavatory of claim 1, further comprising a second transfer handle extending from the center wall at a height below a height of the assist handle.

7. The aircraft lavatory of claim 2, further comprising a trash receptacle disposed on the first wall between the sink and the rear wall.

8. The aircraft lavatory of claim 7, wherein the assist handle is disposed vertically above the trash receptacle, and wherein the first transfer handle is coupled to the trash receptacle.

9. An aircraft lavatory, comprising:
a first single lavatory including a first assist handle disposed on a first wall of the first single lavatory and including a first transfer handle disposed on the first wall of the first single lavatory below the first assist handle;
a second single lavatory including a second assist handle disposed on a second wall of the second single lavatory and including a second transfer handle disposed on the second wall of the second single lavatory below the second assist handle; and
a center wall disposed between the first single lavatory and the second single lavatory, wherein the center wall is convertible within the aircraft lavatory in order to convert the aircraft lavatory between a dual lavatory configuration and a single lavatory configuration.

10. The aircraft lavatory of claim 9, wherein the first single lavatory further includes:
a sink disposed on the first wall proximate a first door of the first single lavatory; and
a trash receptacle disposed on the first wall between the sink and a rear wall of the first single lavatory.

11. The aircraft lavatory of claim 10, wherein the first assist handle extends along the first wall between the sink and the rear wall, and wherein the first assist handle is disposed vertically above the trash receptacle.

12. The aircraft lavatory of claim 10, wherein the first assist handle extends vertically above the trash receptacle, and wherein the first transfer handle protrudes from the trash receptacle.

13. The aircraft lavatory of claim 9, further comprising a third transfer handle disposed on the center wall, facing the first single lavatory, and below the first assist handle.

14. The aircraft lavatory of claim 9, wherein the first transfer handle defines an elongated cutout.

15. An aircraft comprising:
an aircraft lavatory including:
a first wall extending between a door and a rear wall,
a center wall opposing the first wall,
an assist handle, and
a first transfer handle disposed below the assist handle.

16. The aircraft of claim 15, wherein the aircraft is a narrowbody aircraft and the rear wall is an outboard wall of the narrowbody aircraft.

17. The aircraft of claim 15, further comprising:
a sink disposed on the first wall proximate the door of the aircraft lavatory, and
a trash receptacle disposed on the first wall between the sink and the rear wall of the aircraft lavatory.

18. The aircraft of claim 17, wherein the assist handle extends along the first wall between the sink and the rear wall, and wherein the assist handle is disposed vertically above the trash receptacle.

19. The aircraft of claim 17, wherein the assist handle extends vertically above the trash receptacle, and wherein the first transfer handle protrudes from the trash receptacle.

20. The aircraft of claim 15, further comprising a second transfer handle extending from the center wall at a height below a height of the assist handle.
